(19) United States
(12) Patent Application Publication
(10) Pub. No.: US 2025/0199790 A1
(43) Pub. Date: Jun. 19, 2025

(54) CONTROL METHOD AND MANAGEMENT DEVICE

(71) Applicant: Panasonic Automotive Systems Co., Ltd., Kanagawa (JP)

(72) Inventors: Takayoshi ITO, Osaka (JP); Yuishi TORISAKI, Osaka (JP); Shoichiro SEKIYA, Osaka (JP)

(73) Assignee: Panasonic Automotive Systems Co., Ltd., Kanagawa (JP)

(21) Appl. No.: 18/960,155

(22) Filed: Nov. 26, 2024

(30) Foreign Application Priority Data
Dec. 18, 2023 (JP) 2023-212916

(51) Int. Cl. G06F 8/60; G06F 8/71; G06F 8/73

(52) U.S. Cl. CPC G06F 8/60; G06F 8/71; G06F 8/73

(57) ABSTRACT

A control method includes (a) storing an authorized SBOM in a storage, (b) generating an unauthorized SBOM in accordance with the authorized SBOM stored in the storage, the unauthorized SBOM corresponding to an SBOM obtained by modifying at least part of the authorized SBOM, and (c) transmitting the unauthorized SBOM generated in the generating (b) described above to an external device via a network.

### CROSS REFERENCE TO RELATED APPLICATION

The present application is based on and claims priority of Japanese Patent Application No. 2023-212916 filed on Dec. 18, 2023.

### FIELD

The present disclosure relates to a control method and a management device.

### BACKGROUND

Detection systems that detect leakage of bill-of-materials data are known (see, for example, Patent Literature (PTL) 1). For example, in the case where a person in charge who belongs to an organization has the authority to access bill-of-materials data that is used in product designing tasks, a detection system may limit the authority of the person in charge over the bill-of-materials data in response to a change or the like in the tasks of the person in charge due to personnel shifts within the organization.

### CITATION LIST

### Patent Literature

PTL 1: International Publication No. 2014/192078

### Summary

The conventional detection system described above can be improved upon.

The present disclosure provides a control method and a management device that are capable of further improving upon the above related art.

A control method according to a first aspect of the present disclosure is a control method for use in a management device that manages authorized software component information indicating an inventory of a plurality of software components that make up software. The control method includes (a) storing the authorized software component information in a storage, (b) generating unauthorized software component information in accordance with the authorized software component information stored in the storage, the unauthorized software component information corresponding to software component information obtained by modifying at least part of the authorized software component information, and (c) transmitting the unauthorized software component information generated in the generating (b) to an external device via a network.

Note that the comprehensive or specific aspect may be implemented as a system, a method, an integrated circuit, a computer program, or a computer-readable recording medium such as a compact-disc read-only memory (CD-ROM), or may be implemented as any combination of a system, a method, an integrated circuit, a computer program, and a recording medium.

The control method and so on according to one aspect of the present disclosure is capable of further improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing a configuration of a management system according to Embodiment 1.

FIG. 2 shows one example of an authorized SBOM according to Embodiment 1.

FIG. 3 is a diagram showing one example of an unauthorized SBOM according to Embodiment 1.

FIG. 4 is a sequence diagram showing a procedure of operations of the management system according to Embodiment 1.

FIG. 5 is a block diagram showing a configuration of a management system according to Embodiment 2.

FIG. 6 is a diagram showing one example of an unauthorized SBOM according to Embodiment 2.

FIG. 7 is a sequence diagram showing a procedure of operations of the management system according to Embodiment 2.

FIG. 8 is a block diagram showing a configuration of a management system according to Embodiment 3.

FIG. 9 is a diagram showing one example of an unauthorized SBOM according to Embodiment 3.

FIG. 10 is a sequence diagram showing a procedure of operations of the management system according to Embodiment 3.

FIG. 11 is a block diagram showing a configuration of a management system according to Embodiment 4.

FIG. 12 is a diagram showing one example of an unauthorized SBOM according to Embodiment 4.

FIG. 13 is a sequence diagram showing a procedure of operations of the management system according to Embodiment 4.

### DESCRIPTION OF EMBODIMENTS

### Underlying Knowledge Forming Basis of the Present Disclosure

The inventors of the present disclosure have found the following issue concerning the technology described in “Background”.

In recent years, software bills of materials (SBOM), which show an inventory of a plurality of software components that make up software, increase in importance. For example, in the case where an organization has developed software, an SBOM for the software may be provided from the organization to an external vulnerability management server in order to analyze the vulnerability of the software.

When an SBOM is provided from an organization to the outside in this way, a risk of leakage of the SBOM becomes an issue. The aforementioned conventional detection system is applicable to cases of leakage of SBOM data within organizations, but inapplicable to cases of leakage of SBOM from an organization to the outside.

To solve such an issue, the inventors of the present disclosure have come up with a control method and a management device described below.

### Technique 1

A control method for use in a management device that manages authorized software component information indicating an inventory of a plurality of software components that make up software includes (a) storing the authorized software component information in a storage, (b) generating unauthorized software component information in accordance with the authorized software component information stored in the storage, the unauthorized software component information corresponding to software component information obtained by modifying at least part of the authorized software component information, and (c) transmitting the unauthorized software component information generated in the generating (b) to an external device via a network.

According to Technique 1, the unauthorized software component information corresponding to the software component information is generated based on the authorized software component information, the software component information being obtained by modifying at least part of the authorized software component information stored in the storage. Then, the generated unauthorized software component information is transmitted to the external device via the network. Accordingly, even if the unauthorized software component information provided from the management device to the external device has leaked to an attacker who tries to, for example, hack the information, (i) the unauthorized software component information does not include information required by the attacker, or (ii) it is difficult for the attacker to determine the authenticity of the unauthorized software component information. As a result, it is possible to reduce a risk of leakage of the authorized software component information.

### Technique

### 2

In the control method according to Technique 1, the generating (b) includes, when at least one dependency exists among the plurality of software components indicated by the authorized software component information, generating the unauthorized software component information corresponding to software component information that has resolved the at least one dependency included in the authorized software component information.

According to Technique 2, the unauthorized software component information resolves at least one dependency of the plurality of software components indicated by the authorized software component information. Accordingly, the unauthorized software component information includes coarse information about dependencies of the plurality of software components. Here, the information about dependencies of the plurality of software components is of low importance to the analysis of vulnerability conducted by the external device (e.g., a vulnerability management server), but is useful information for the attacker. Thus, even if the unauthorized software component information provided from the management device to the external device has leaked to the attacker, the attacker is unable to know detailed dependencies of the plurality of software components and therefore has difficulty in estimating where each of the plurality of software components runs within the software. As a result, it is possible to reduce a risk of leakage of the authorized software component information without a hitch to the analysis of vulnerability conducted by the external device.

### Technique 3

The control method according to Technique 1 or 2 further includes (d) transmitting the authorized software component information stored in the storage to the external device via the network, (e) receiving authorized response information from the external device via the network in response to the authorized software component information transmitted in the transmitting (d), and (f) receiving unauthorized response information from the external device via the network in response to the unauthorized software component information transmitted in the transmitting (c).

According to Technique 3, the software component information provided from the management device to the external device includes the authorized software component information transmitted in a normal session (i.e., a normal exchange of data between the management device and the external device) and the unauthorized software component information transmitted in a dummy session (i.e., a dummy exchange of data between the management device and the external device). Thus, even if the authorized software component information and the unauthorized software component information provided from the management device to the external device have leaked to an attacker, it is difficult for the attacker to determine which of the software component information to believe in. As a result, it is possible to confuse the attacker and to reduce a risk of leakage of the authorized software component information.

### Technique 4

The control method according to Technique 3 further includes (g) discarding the unauthorized response information received in the receiving (f).

According to Technique 4, it is possible to save the storage capacity of the management device by discarding the unnecessary unauthorized response information.

### Technique 5

In the control method according to any one of Techniques 1 to 4, the generating (b) includes tampering with at least part of the authorized software component information stored in the storage to generate the authorized software component information tampered with as the unauthorized software component information.

According to Technique 5, the software component information provided from the management device to the external device is the unauthorized software component information obtained by the management device itself tampering at least part of the authorized software component information. Thus, even if the unauthorized software component information provided from the management device to the external device has leaked to an attacker, it is difficult for the attacker to know the contents of the authorized software component information. As a result, it is possible to confuse the attacker and to reduce a risk of leakage of the authorized software component information.

### Technique 6

The control method according to Technique 5 further includes (h) receiving response information from the external device via the network in response to the unauthorized software component information transmitted in the transmitting (c), and (i) restoring tampered information included in the response information received in the receiving (h) to original information before tampering.

According to Technique 6, the tampered information included in the received response information is restored to original information before tampering. This, for example, allows the management device to safely acquire the analysis result for the vulnerability of the software in accordance with the restored response information.

### Technique 7

In the control method according to any one of Techniques 1 to 6, the authorized software component information includes a plurality of name information items that respectively indicate names of the plurality of software components, and the generating (b) includes pseudonymizing each of the plurality of name information items included in the authorized software component information stored in the storage to generate the authorized software component information pseudonymized as the unauthorized software component information.

According to Technique 7, the software component information provided from the management device to the external device is the unauthorized software component information obtained by pseudonymizing each of the plurality of name information items included in the authorized software component information. Thus, even if the unauthorized software component information provided from the management device to the external device has leaked to an attacker, it is difficult for the attacker to identify the contents of the authorized software component information. As a result, it is possible to confuse the attacker and to reduce a risk of leakage of the authorized software component information.

### Technique 8

The control method according to Technique 7 further includes (j) receiving response information from the external device via the network in response to the unauthorized software component information transmitted in the transmitting (c), and (k) restoring each of the plurality of name information items pseudonymized and included in the response information received in the receiving (j) to the plurality of name information items before pseudonymization.

According to Technique 8, the plurality of name information items pseudonymized and included in the received response information are restored to original name information items before pseudonymization. This, for example, allows the management device to safely acquire the analysis result for the vulnerability of the software in accordance with the restored response information.

### Technique 9

A management device that manages authorized software component information indicating an inventory of a plurality of software components that make up software includes a storage that stores the authorized software component information, a generator that generates unauthorized software component information in accordance with the authorized software component information stored in the storage, the unauthorized software component information corresponding to software component information obtained by modifying at least part of the authorized software component information, and a communicator that transmits the unauthorized software component information generated by the generator to an external device via a network.

According to technique 9, the generator generates the unauthorized software component information corresponding to the software component information in accordance with the authorized software component information, the software component information being obtained by modifying at least part of the authorized software component information stored in the storage. Then, the communicator transmits the unauthorized software component information generated by the generator to the external device via the network. Thus, even if the unauthorized software component information provided from the management device to the external device has leaked to an attacker who tries to, for example, hack the information, (i) the unauthorized software component information does not include information required by the attacker, or (ii) it is difficult for the attacker to determine the authenticity of the unauthorized software component information. As a result, it is possible to reduce a risk of leakage of the authorized software component information.

Note that these comprehensive or specific aspects may be implemented as systems, methods, integrated circuits, computer programs, or computer-readable recording media such as CD-ROMs, or may be implemented as any combination of systems, methods, integrated circuits, computer programs, and recording media.

Hereinafter, embodiments will be described with reference to the drawings.

Note that each embodiment described below illustrates one generic or specific example. Numerical values, shapes, materials, constituent elements, positions of arrangement and forms of connection of the constituent elements, steps, a sequence of steps, and so on in the following embodiments are merely one example and do not intend to limit the scope of the present disclosure. Among the constituent elements described in the following embodiments, those that are not recited in any independent claim, which represents the broadest concept, are described as optional constituent elements.

### Embodiment 1

### 1-1. Configuration of Management System

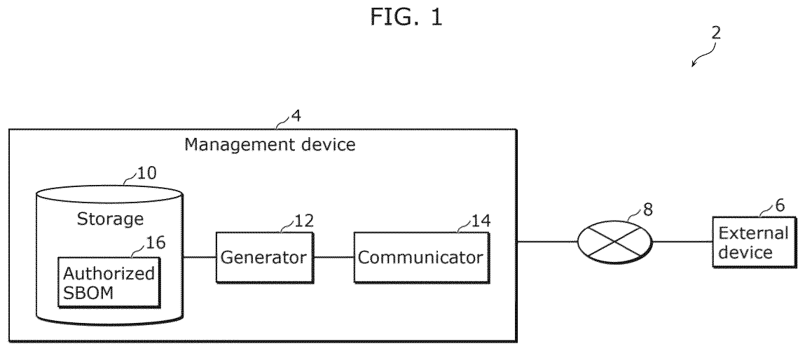

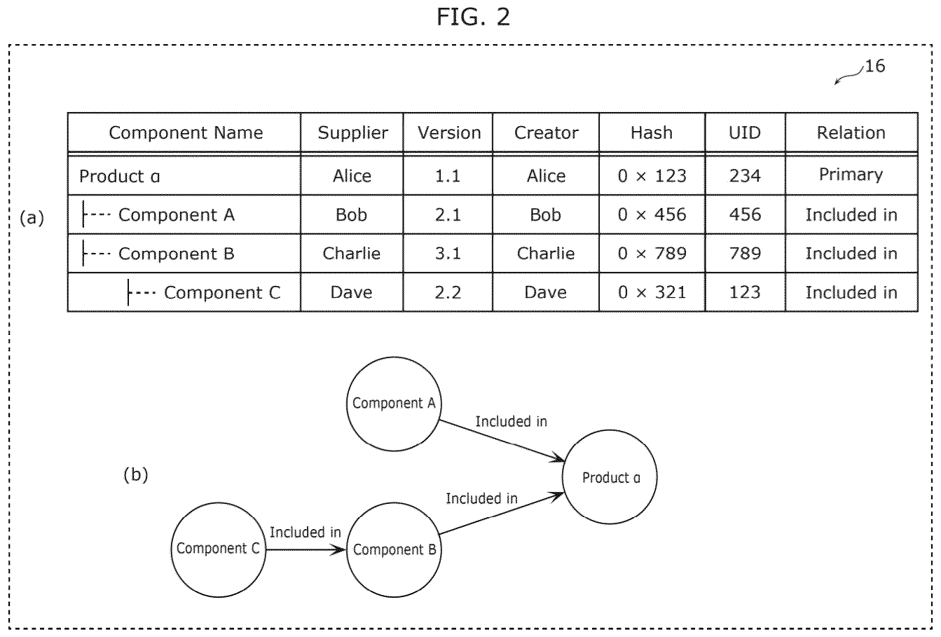

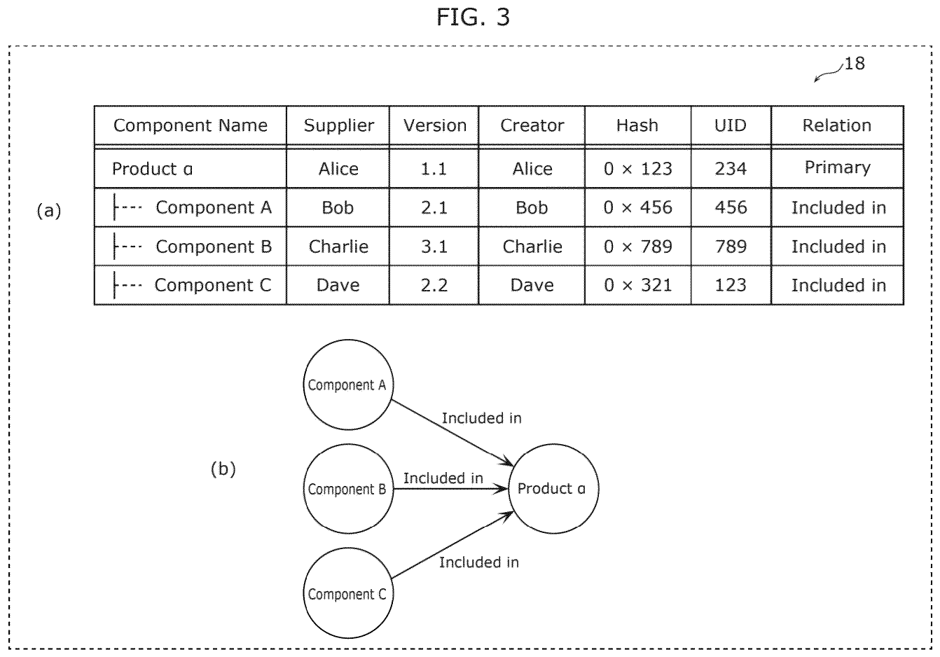

First, a configuration of management system 2 according to Embodiment 1 is described with reference to FIGS. 1 to 3. FIG. 1 is a block diagram showing the configuration of management system 2 according to Embodiment 1. FIG. 2 shows one example of authorized SBOM 16 according to Embodiment 1. FIG. 3 is a diagram showing one example of unauthorized SBOM 18 according to Embodiment 1.

As shown in FIG. 1, management system 2 according to Embodiment 1 includes management device 4 and external device 6. Management device 4 and external device 6 are capable of communicating with each other via, for example, network 8 such as the Internet.

Management device 4 is a device for managing an authorized SBOM (one example of authorized software component information) that shows an inventory of a plurality of software components that make up software. For example, management device 4 may be configured as a personal computer or the like and owned by an entity (e.g., a corporation, a group, an organization, or an individual) that develops software as products.

The “authorized SBOM” as used herein refers to an SBOM (one example of software component information) that includes authorized information about a plurality of software components that make up software (i.e., information that has not received no modifications such as tampering).

Management device 4 includes storage 10, generator 12, and communicator 14.

Storage 10 serves as memory that stores authorized SBOM 16. Authorized SBOM 16 may, for example, be a data table as shown in (a) in FIG. 2. For example, authorized SBOM 16 may be information indicating correspondence relations of a component name (one example of name information), a supplier, a version, a creator, a hash, an unique identifier (UID), and a relation as shown in (a) in FIG. 2.

The component name is the name of the component defined by the supplier. Note that the component is a concept including software (product) and a plurality of software components that make up the software. The component name also includes indent information that corresponds to a dependency indicated by the relation described later.

The supplier is the name of the entity that has developed the component.

The version is the identifier for the version used to identify the component.

The creator is the name of the entity that has created the SBOM of the component.

The hash is the hash value of the component.

The UID is the identifier used to identify the component.

The relation is information indicating the dependency of the component being included in another component.

Although not shown in (a) in FIG. 2, authorized SBOM 16 may further include a time stamp that is information indicating the date and time of creation of the SBOM.

In the example shown in (a) in FIG. 2, the first row of authorized SBOM 16 contains (a) “Product α” as the component name, (b) “Alice” as the supplier, (c) “1.1” as the version, (d) “Alice” as the creator, (e) “0x123” as the hash, (f) “234” as the UID, and (g) “Primary” as the relation.

The second row of the authorized SBOM 16 contains (a) “Component A” as the component name, (b) “Bob” as the supplier, (c) “2.1” as the version, (c) “Bob” as the creator, (e) “0x456” as the hash, (f) “456” as the UID, (g) and “Included in” as the relation. Note that the indent information contained together with the component name of “Component A” indicates the dependency indicating that Component A is included in Product α.

The third row of authorized SBOM 16 contains (a) “Component B” as the component name, (b) “Charlie” as the supplier, (c) “3.1” as the version, (d) “Charlie” as the creator, (e) “0x789” as the hash, (f) “789” as the UID, and (g) “Included in” as the relation. Note that the indent information contained together with the component name of “Component B” indicates the dependency indicating that Component B is included in Product α.

The fourth row of authorized SBOM 16 contains (a) “Component C” as the component name, (b) “Dave” as the supplier, (c) “2.2” as the version, (d) “Dave” as the creator, (e) “0x321” as the hash, (f) “123” as the UID, (g) and “Included in” as the relation. Note that the indent information contained together with the component name of “Component C” indicates the dependency indicating that Component C is included in Component B.

That is, authorized SBOM 16 indicates that the supplier named as “Alice” has developed the software (product) named as “Product α” by using the three software components including (i) “Component A” developed by the supplier named as “Bob”, (ii) “Component B” developed by the supplier named as “Charlie”, and (iii) “Component C” developed by the supplier named as “Dave”.

As shown in (b) in FIG. 2, the relationship of Product α and Components A, B, and C in authorized SBOM 16 has a nested structure (tree structure) in which Component A is included in Product α, Component B is included in Product α, and Component C is included in Component B. This nested structure means that Component A runs on Product α, Component B runs on Product α, and Component C runs on Component B. That is, one dependency indicating that “Component C is included in Component B” exists among the three software components in authorized SBOM 16, namely, Components A, B, and C. While the present embodiment describes the case in which one dependency exists among the plurality of software components in authorized SBOM 16, the present disclosure is not limited to this example, and two or more dependencies may exist among the plurality of software components.

Referring back to FIG. 1, generator 12 generates unauthorized SBOM 18 (one example of unauthorized software component information) in accordance with authorized SBOM 16 stored in storage 10, the unauthorized SBOM corresponding to the SBOM obtained by modifying at least part of authorized SBOM 16. Specifically, generator 12 generates unauthorized SBOM 18 corresponding to the SBOM obtained by resolving dependencies of the plurality of software components included in authorized SBOM 16 (i.e., flattening the nested structure of the plurality of software components).

Generator 12 may generate unauthorized SBOM 18 by overwriting authorized SBOM 16 stored in storage 10, or may generate unauthorized SBOM 18 by copying authorized SBOM 16 stored in storage 10 and overwriting copied authorized SBOM 16. Generator 12 may store generated unauthorized SBOM 18 in storage 10.

Unauthorized SBOM 18 may, for example, be a data table as shown in (a) in FIG. 3. Like authorized SBOM 16, unauthorized SBOM 18 may, for example, be information indicating correspondence relations of the component name, the supplier, the version, the creator, the hash, the UID, and the relation as shown in (a) in FIG. 3.

In the example shown in (a) in FIG. 3, unauthorized SBOM 18 differs in the component name contained in the fourth row from authorized SBOM 16. Specifically, the indent information contained together with the component name of “Component C” in the fourth row of unauthorized SBOM 18 indicates the dependency indicating that Component C is included in Product α. Accordingly, the relationship of Product α and Components A, B, and C in unauthorized SBOM 18 has a flatted nested structure as shown in (b) in FIG. 3 in which Component A is included in Product α, Component B is included in Product α, and Component C is included in Product α. That is, unauthorized SBOM 18 resolves the dependency indicating that “Component C is included in Component B” in authorized SBOM 16.

Referring back to FIG. 1, communicator 14 transmits unauthorized SBOM 18 generated by generator 12 to external device 6 via network 8 when it becomes necessary to analyze the vulnerability of the software (product). Communicator 14 also receives response information from external device 6 via network 8 in response to transmitted unauthorized SBOM 18.

External device 6 serves as a vulnerability management server arranged outside management device 4. External device 6 receives unauthorized SBOM 18 from management device 4 via network 8. Then, external device 6 analyzes the vulnerability of the software (product) in accordance with received unauthorized SBOM 18 by using, for example, a common vulnerabilities and exposures (CVE) identifier (CVE). External device 6 also transmits response information indicating the analysis result to management device 4 via network 8.

### 1-2. Operations of Management System

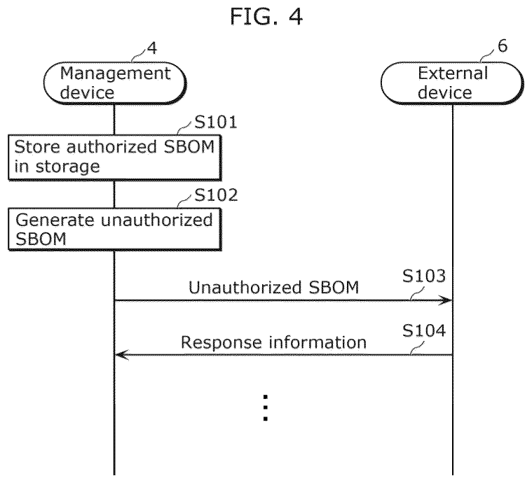

Next, operations of management system 2 (a control method in management device 4) according to Embodiment 1 are described with reference to FIG. 4. FIG. 4 is a sequence diagram showing a procedure of the operations of management system 2 according to Embodiment 1.

As shown in FIG. 4, first, storage 10 of management device 4 stores authorized SBOM 16 (S101).

Then, generator 12 of management device 4 generates unauthorized SBOM 18 in accordance with authorized SBOM 16 stored in storage 10 (S102).

Then, communicator 14 of management device 4 transmits unauthorized SBOM 18 generated by generator 12 to external device 6 via network 8 (S103).

Then, external device 6 receives unauthorized SBOM 18 from management device 4 via network 8 and analyzes the vulnerability of the software (product) in accordance with received unauthorized SBOM 18.

Then, external device 6 transmits response information indicating the analysis result to management device 4 via network 8 (S104). Although not shown, steps S103 and S104 may be executed repeatedly.

Then, communicator 14 of management device 4 receives the response information from external device 6 via network 8.

### 1-3. Effects

In the present embodiment, the SBOM provided from management device 4 to external device 6 is not authorized SBOM 16, but unauthorized SBOM 18. Unauthorized SBOM 18 has resolved at least one dependency of the plurality of software components included in authorized SBOM 16. Accordingly, unauthorized SBOM 18 includes coarse information about dependencies of the plurality of software components.

Here, the information about dependencies of the plurality of software components is of low importance to the analysis of the vulnerability conducted by external device 6, but is useful information for an attacker who tries to, for example, hack the information. Thus, even if unauthorized SBOM 18 provided from management device 4 to external device 6 has leaked to the attacker, the attacker is unable to know detailed dependencies of the plurality of software components and therefore has difficulty in estimating where each of the plurality of software components runs within the software (product).

As a result, it is possible to reduce a risk of leakage of authorized SBOM 16 without a hitch to the analysis of the vulnerability conducted by external device 6.

### Embodiment 2

### 2-1. Configuration of Management System

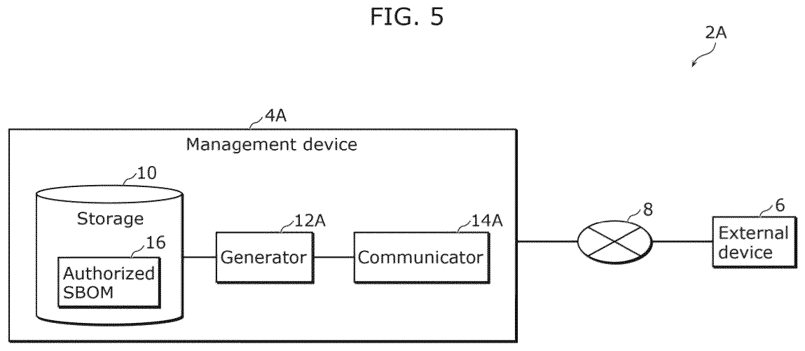

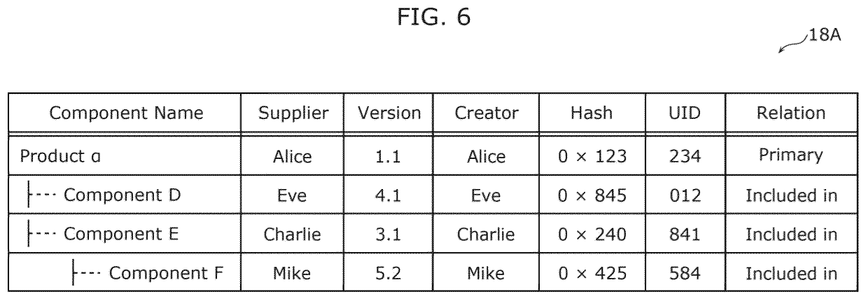

A configuration of management system 2A according to Embodiment 2 is described with reference to FIGS. 5 and 6. FIG. 5 is a block diagram showing the configuration of management system 2A according to Embodiment 2. FIG. 6 is a diagram showing one example of unauthorized SBOM 18A according to Embodiment 2. In the present embodiment, constituent elements that are identical to those described above in Embodiment 1 are given the same reference signs, and descriptions thereof shall be omitted.

As shown in FIG. 5, management system 2A according to Embodiment 2 differs in the configurations of generator 12A and communicator 14A of management device 4A from the system described above in Embodiment 1.

Specifically, generator 12A generates unauthorized SBOM 18A by copying authorized SBOM 16 (see (a) in FIG. 2) stored in storage 10 and modifying part of copied authorized SBOM 16.

As shown in FIG. 6, the second to fourth rows of unauthorized SBOM 18A contain dummy information obtained by modifying the information contained in the second to fourth rows of authorized SBOM 16. That is, unauthorized SBOM 18A indicates dummy information indicating that the supplier named as “Alice” has developed the software (product) named as “Product α” by using the three software components including (i) “Component D” developed by the supplier named as “Eve”, (ii) “Component E” developed by the supplier named as “Charlie”, and (iii) “Component F” developed by the supplier named as “Mike”.

Generator 12A dynamically generates unauthorized SBOM 18A with timing of, for example, upgrading the version of the software (product). Each “Version” stored in unauthorized SBOM 18A is updated to the latest information every time generator 12A generates unauthorized SBOM 18A.

While generator 12A according to the present embodiment generates one unauthorized SBOM 18A for one authorized SBOM 16, the present disclosure is not limited to this example, and a plurality of different unauthorized SBOMS 18A may be generated for one authorized SBOM 16.

Referring back to FIG. 5, communicator 14A executes a normal session and a dummy session, the normal session being a normal exchange of data between management device 4A and external device 6, the dummy session being a dummy exchange of data between management device 4A and external device 6. In the normal session, communicator 14A (i) transmits authorized SBOM 16 stored in storage 10 to external device 6 via network 8 and (ii) receives authorized response information from external device 6 via network 8, the authorized response information being response information received in response to transmitted authorized SBOM 16. In the dummy session, communicator 14A (iii) transmits unauthorized SBOM 18A generated by generator 12A to external device 6 via network 8 and (iv) receives unauthorized response information from external device 6 via network 8, the unauthorized response information being response information received in response to transmitted unauthorized SBOM 18A. Communicator 14A also discards the unauthorized response information received in the dummy session.

### 2-2. Operations of Management System

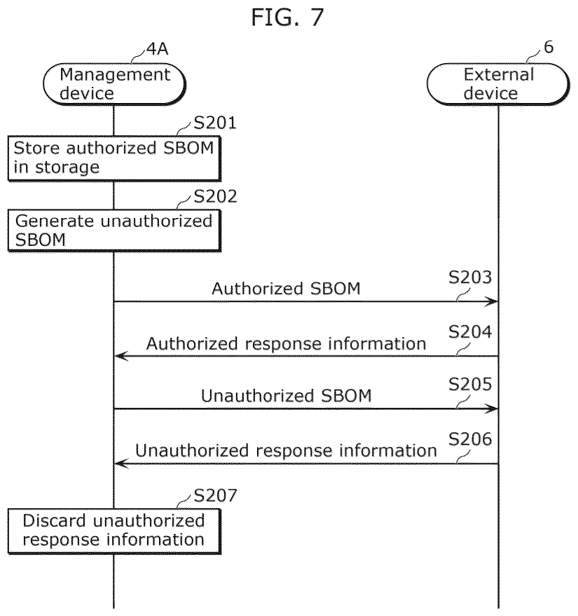

Next, operations of management system 2A (a control method in management device 4A) according to Embodiment 2 are described with reference to FIG. 7. FIG. 7 is a sequence diagram showing a procedure of the operations of management system 2A according to Embodiment 2.

As shown in FIG. 7, first, storage 10 of management device 4A stores authorized SBOM 16 (S201).

Then, generator 12A of management device 4A generates unauthorized SBOM 18A in accordance with authorized SBOM 16 stored in storage 10 (S202).

Then, communicator 14A of management device 4A transmits authorized SBOM 16 stored in storage 10 to external device 6 via network 8 (S203).

Then, external device 6 receives authorized SBOM 16 from management device 4A via network 8 and analyzes the vulnerability of the software (product) in accordance with received authorized SBOM 16. Then, external device 6 transmits authorized response information indicating the analysis result to management device 4A via network 8 (S204).

Then, communicator 14A of management device 4A receives the authorized response information from external device 6 via network 8.

Then, communicator 14A of management device 4A transmits unauthorized SBOM 18A generated by generator 12A to external device 6 via network 8 (S205).

Then, external device 6 receives unauthorized SBOM 18A from management device 4A via network 8 and analyzes the vulnerability of the software (product) as a dummy in accordance with received unauthorized SBOM 18A. Then, external device 6 transmits the unauthorized response information indicating the analysis result to management device 4A via network 8 (S206).

Then, communicator 14A of management device 4A receives the unauthorized response information from external device 6 via network 8. Then, communicator 14A discards the received unauthorized response information (S207).

While one normal session and one dummy session are executed in the present embodiment, the present disclosure is not limited to this example, and the number of times the dummy session is executed may be in the range of one to N (where N≥2). In this case, the order of execution of the normal session and the dummy session(s) may be random. For example, in the case where a dummy session is executed three times in total, the order of execution of the sessions may, for example, be as follows: dummy session A, normal session A, dummy session B, and dummy session C″.

2-3. Effects

In the present embodiment, the SBOM provided from management device 4A to external device 6 includes authorized SBOM 16 transmitted in the normal session and unauthorized SBOM 18A transmitted in the dummy session. Thus, even if authorized SBOM 16 and unauthorized SBOM 18A provided from management device 4A to external device 6 have leaked to an attacker, it is difficult for the attacker to determine which of the SBOMS to believe in.

As a result, it is possible to confuse the attacker and to reduce a risk of leakage of authorized SBOM 16.

### Embodiment 3

### 3-1. Configuration of Management System

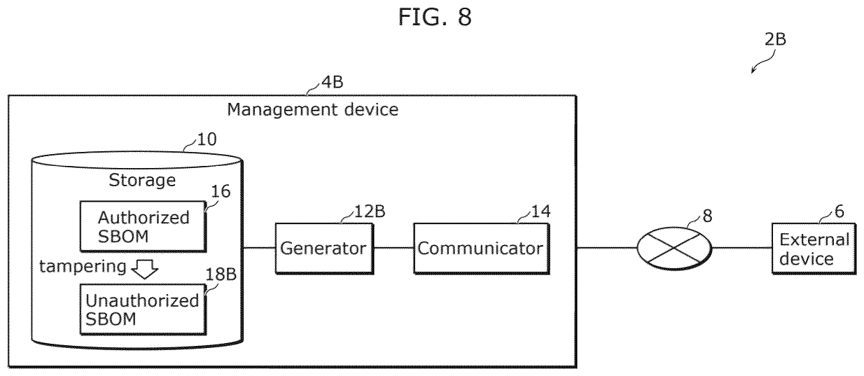

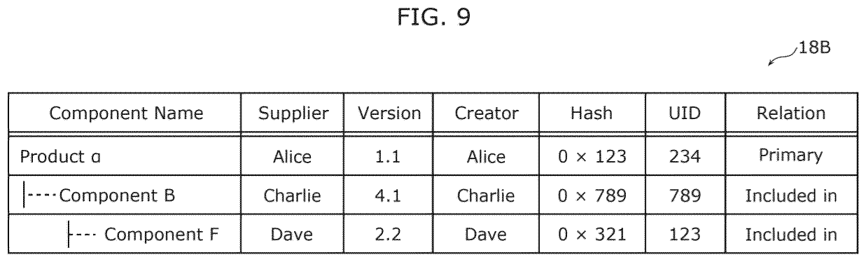

A configuration of management system 2B according to Embodiment 3 is described with reference to FIGS. 8 and 9. FIG. 8 is a block diagram showing the configuration of management system 2B according to Embodiment 3. FIG. 9 is a diagram showing one example of unauthorized SBOM 18B according to Embodiment 3. In the present embodiment, constituent elements that are identical to those described above in Embodiment 1 are given the same reference signs, and descriptions thereof shall be omitted.

As shown in FIG. 8, management system 2B according to Embodiment 3 differs in the configuration of generator 12B of management device 4B from the system described above in Embodiment 1.

Specifically, generator 12B generates tampered authorized SBOM 16 as unauthorized SBOM 18B by tampering with and overwriting at least part of authorized SBOM 16 (see (a) in FIG. 2) stored in storage 10. That is, generator 12B generates unauthorized SBOM 18B that is a poisoned SBOM through so-called self-poisoning in which management device 4B itself tampers with at least part of authorized SBOM 16.

As shown in FIG. 9, unauthorized SBOM 18B indicates dummy information obtained by deleting the second row from authorized SBOM 16, modifying the version of “3.1” in the third row of authorized SBOM 16 to the version of “4.1” in the second row of unauthorized SBOM 18B, and modifying the component name of “Component C” in the fourth row to the component name of “Component F” in the third row.

That is, unauthorized SBOM 18B indicates the dummy information indicating that the supplier named as “Alice” has developed the software (product) named as “Product α” by using the two software components including (i) “Component B” developed by the supplier named as “Charlie” and (ii) “Component F” developed by the supplier named as “Dave”.

Generator 12B also restores (detoxicates) the tampered information included in the response information to original information before tampering when communicator 14 has received the response information from communicator 14 in response to unauthorized SBOM 18B.

### 3-2. Operations of Management System

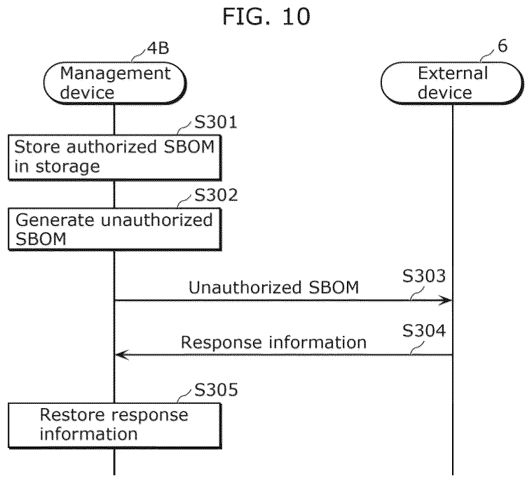

Next, operations of management system 2B (a control method in management device 4B) according to Embodiment 3 are described with reference to FIG. 10. FIG. 10 is a sequence diagram showing a procedure of the operations of management system 2B according to Embodiment 3.

As shown in FIG. 10, first, storage 10 of management device 4B stores authorized SBOM 16 (S301).

Then, generator 12B of management device 4B generates unauthorized SBOM 18B in accordance with authorized SBOM 16 stored in storage 10 (S302).

Then, communicator 14 of management device 4B transmits unauthorized SBOM 18B generated by generator 12B to external device 6 via network 8 (S303).

Then, external device 6 receives unauthorized SBOM 18B from management device 4B via network 8 and analyzes the vulnerability of the software (product) in accordance with received unauthorized SBOM 18B. Then, external device 6 transmits response information indicating the analysis result to management device 4B via network 8 (S304).

Then, communicator 14 of management device 4B receives the response information from external device 6 via network 8. Then, generator 12B of management device 4B restores the tampered information included in the response information received by communicator 14 to original information before tampering (S305). This allows management device 4B to safely acquire the analysis result for the vulnerability of the software (product) in accordance with the restored response information.

### 3-3. Effects

In the present embodiment, the SBOM provided from management device 4B to external device 6 is unauthorized SBOM 18B obtained by management device 4B itself tampering with at least part of authorized SBOM 16. Thus, even if unauthorized SBOM 18B provided from management device 4B to external device 6 has leaked to an attacker, it is difficult for the attacker to know the contents of authorized SBOM 16.

As a result, it is possible to confuse the attacker and to reduce a risk of leakage of authorized SBOM 16.

### Embodiment 4

### 4-1. Configuration of Management System

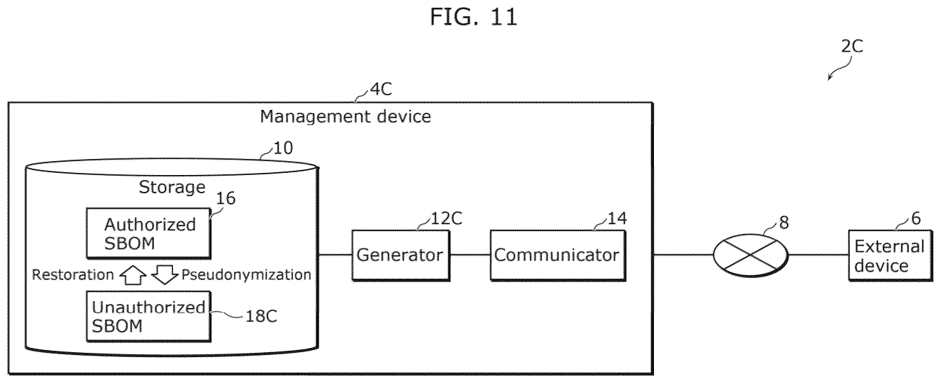

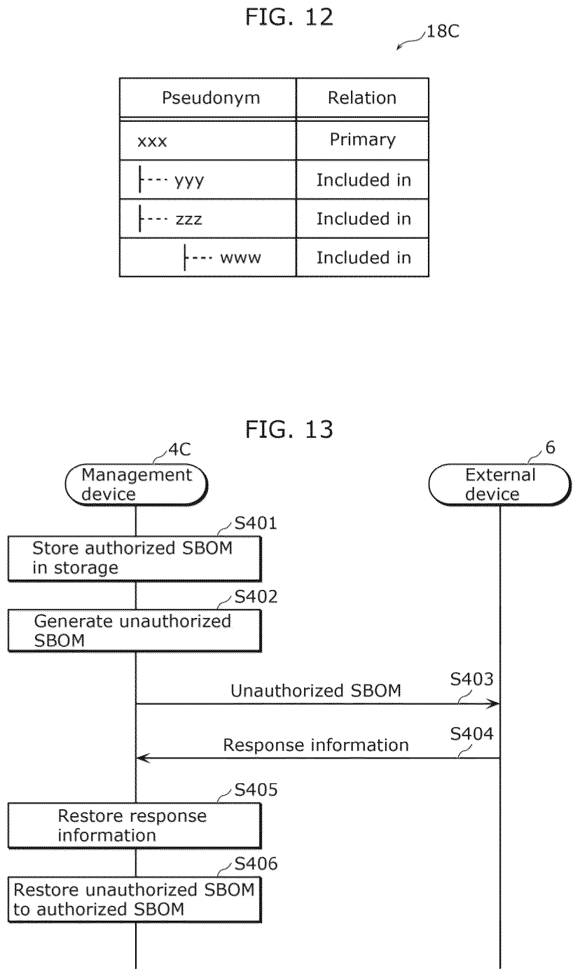

A configuration of management system 2C according to Embodiment 4 is described with reference to FIGS. 11 and 12. FIG. 11 is a block diagram showing the configuration of management system 2C according to Embodiment 4. FIG. 12 is a diagram showing one example of unauthorized SBOM 18C according to Embodiment 4. In the present embodiment, constituent elements that are identical to those described above in Embodiment 1 are given the same reference signs, and descriptions thereof shall be omitted.

As shown in FIG. 11, management system 2C according to Embodiment 4 differs in the configuration of generator 12C of management device 4C from the system described above in Embodiment 1.

Specifically, generator 12C generates pseudonymized authorized SBOM 16 as unauthorized SBOM 18C by pseudonymizing and overwriting each of a plurality of component names and a plurality of versions included in authorized SBOM 16 (see (a) in FIG. 2) stored in storage 10. At this time, for the pseudonymization, generator 12C may, for example, hash each of the component names and each of the versions included in authorized SBOM 16 by using a hash function.

As shown in FIG. 12, the first row of unauthorized SBOM 18C contains “xxx” as a pseudonym that is obtained by hashing the component name of “Product α” and the version of “1.1” in the first row of authorized SBOM 16 for pseudonymization. That is, the pseudonym of “xxx” corresponds to a hash value obtained by hashing the component name of “Product α” and the version of “1.1”.

The second row of unauthorized SBOM 18C contains “yyy” as a pseudonym that is obtained by hashing the component name of “Component A” and the version of “2.1” in the second row of authorized SBOM 16 for pseudonymization. That is, the pseudonym of “yyy” corresponds to a hash value obtained by hashing the component name of “Component A” and the version of “2.1”.

The third row of unauthorized SBOM 18C contains “zzz” as a pseudonym that is obtained by hashing the component name of “Component B” and the version of “3.1” in the third row of authorized SBOM 16 for pseudonymization. That is, the pseudonym of “zzz” corresponds to a hash value obtained by hashing the component name of “Component B” and the version of “3.1”.

The fourth row of unauthorized SBOM 18C contains “www” as a pseudonym that is obtained by hashing the component name of “Component C” and the version of “2.2” in the fourth row of authorized SBOM 16 for pseudonymization. That is, the pseudonym of “www” corresponds to a hash value obtained by hashing the component name of “Component C” and the version of “2.2”.

Generator 12C restores the pseudonymized information (component name and version) included in the response information to original information before pseudonymization when communicator 14 has received the response information from communicator 14 in response to unauthorized SBOM 18C. Generator 12C also restores unauthorized SBOM 18C stored in storage 10 to original authorized SBOM 16 in accordance with a database for restoration.

While generator 12C according to the present embodiment pseudonymizes each of the plurality of component names and the plurality of versions included in authorized SBOM 16, the present disclosure is not limited to this example, and generator 12C may pseudonymize at least the plurality of component names included in authorized SBOM 16.

### 4-2. Operations of Management System

Next, operations of management system 2C (a control method in management device 4C) according to Embodiment 4 are described with reference to FIG. 13. FIG. 13 is a sequence diagram showing a procedure of the operations of management system 2C according to Embodiment 4.

As shown in FIG. 13, first, storage 10 of management device 4C stores authorized SBOM 16 (S401).

Then, generator 12C of management device 4C generates unauthorized SBOM 18C in accordance with authorized SBOM 16 stored in storage 10 (S402).

Then, communicator 14 of management device 4C transmits unauthorized SBOM 18C generated by generator 12C to external device 6 via network 8 (S403).

Then, external device 6 receives unauthorized SBOM 18C from management device 4C via network 8 and analyzes the vulnerability of the software (product) in accordance with received unauthorized SBOM 18C. Then, external device 6 transmits response information indicating the analysis result to management device 4C via network 8 (S404).

Then, communicator 14 of management device 4C receives the response information from external device 6 via network 8. Then, generator 12C of management device 4C restores the information pseudonymized and included in the response information received by communicator 14 to original information before pseudonymization (S405). This allows management device 4C to safely acquire the analysis result for the vulnerability of the software (product) in accordance with the restored response information.

Then, generator 12C restores unauthorized SBOM 18C stored in storage 10 to original authorized SBOM 16 by using a database for restoration (S406).

### 4-3. Effects

In the present embodiment, the SBOM provided from management device 4C to external device 6 is unauthorized SBOM 18C obtained by pseudonymizing each of the plurality of component names and the plurality of versions included in authorized SBOM 16. Thus, even if unauthorized SBOM 18C provided from management device 4C to external device 6 has leaked to an attacker, it is difficult for the attacker to identify the contents of authorized SBOM 16.

As a result, it is possible to confuse the attacker and to reduce a risk of leakage of authorized SBOM 16.

### Variation 1

Embodiments 1 and 4 described above may be combined together. That is, the generator may generate the unauthorized SBOM by resolving at least one dependency of the plurality of software components included in the authorized SBOM and pseudonymizing each of the plurality of component names and the plurality of versions included in the authorized SBOM. This improves resistance to inference attacks by attackers.

### Variation 2

Embodiments 2 and 4 described above may be combined together. That is, the generator may pseudonymize each of the plurality of component names and the plurality of versions included in the authorized SBOM, and the communicator may execute a normal session and a dummy session. This improves resistance to intensive attacks by attackers.

### Variation 3

Embodiments 1 and 2 described above may be combined together. That is, the generator may resolve at least one dependency of the plurality of software components included in the authorized SBOM, and the communicator may execute a normal session and a dummy session. This improves resistance to intensive attacks by attackers.

### Variation 4

Embodiments 1, 2, and 3 described above may be combined together. That is, the generator may tamper with at least part of the authorized SBOM and then resolve at least one dependency of the plurality of software components included in the authorized SBOM, and the communicator may execute a normal session and a dummy session. This further improves resistance to intensive attacks by attackers.

### Variation 5

Embodiments 1, 2, 3, and 4 described above may be combined together. That is, the generator may tamper with at least part of the authorized SBOM and then resolve at least one dependency of the plurality of software components included in the authorized SBOM and may further pseudonymize each of the plurality of component names and the plurality of versions included in the authorized SBOM, and the communicator may execute a normal session and a dummy session. This improves resistance to inference and intensive attacks by attackers to maximum.

### Other Embodiments

In addition to Variations 1 to 5 described above, two or more of Embodiments 1, 2, 3, and 4 described above may be arbitrarily combined together.

### Other Variations

While the control method and the management device according to one or a plurality of aspects have been described thus far, the present disclosure is not intended to be limited to the above-described embodiments. Other embodiments such as those obtained by making a variety of modifications conceivable by a person skilled in the art to the above-described embodiments or those configured by a combination of constituent elements according to different embodiments may also be included in the range of the one or the plurality of aspects without departing from the scope of the present disclosure.

Note that each constituent element according to the above-described embodiments may be realized as dedicated hardware or by executing a computer program suitable for the constituent element. Each constituent element may be realized by a program executor such as a central processing unit (CPU) or a processor reading out and executing a computer program stored in a recording medium such as a hard disk or semiconductor memory.

Some or all of the functions of the management device according to each embodiment described above may be realized by a processor such as a CPU executing a computer program.

Some or all of the constituent elements that make up each device described above may be configured as an IC card detachable from the device or as a stand-alone module. The IC card or the module may be a computer system that may include, for example, a microprocessor, ROM, and RAM. The IC card or the module may include the ultra-multifunctional LSI described above. The IC card or the module achieves its functions as a result of the microprocessor operating in accordance with computer programs. The IC card or the module may have protection against tampering.

The present disclosure may be implemented as the methods described above. The present disclosure may also be implemented as a computer program that realizes these methods by using a computer, or as digital signals including the computer programs. The present disclosure may also be implemented by recording the computer programs or the digital signals on a non-transitory computer-readable recording medium such as a flexible disk, a hard disk, a CD-ROM, an MO, a DVD, a DVD-ROM, a DVD-RAM, a Blu-ray (registered trademark) disc, or semiconductor memory. The present disclosure may also be implemented as the above-described digital signals recorded on such a recording medium. The present disclosure may also be implemented by transmitting the computer programs or the digital signals via, for example, telecommunication lines, wireless or wired communication lines, networks typified by the Internet, or data broadcasting. The present disclosure may also be implemented as a computer system that includes a microprocessor and memory and in which the memory stores the computer programs and the microprocessor operates in accordance with the computer programs. The present disclosure may also be implemented as another independent computer system by transferring the computer programs or the digital signals recorded on the recording medium or by transferring the computer programs or the digital signals via, for example, the network.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims are incorporated herein by reference in their entirety: Japanese Patent Application No. 2023-212916 filed on Dec. 18, 2023.

### INDUSTRIAL APPLICABILITY

The control method according to the present disclosure is applicable to, for example, a management system or the like for exchanging an authorized SBOM between a management device and an external device.

1. A control method for use in a management device that manages authorized software component information indicating an inventory of a plurality of software components that make up software, the control method comprising:
(a) storing the authorized software component information in a storage;
(b) generating unauthorized software component information in accordance with the authorized software component information stored in the storage, the unauthorized software component information corresponding to software component information obtained by modifying at least part of the authorized software component information; and
(c) transmitting the unauthorized software component information generated in the generating (b) to an external device via a network.

2. The control method according to claim 1,
wherein the generating (b) includes, when at least one dependency exists among the plurality of software components indicated by the authorized software component information, generating the unauthorized software component information corresponding to software component information that has resolved the at least one dependency included in the authorized software component information.

3. The control method according to claim 1, further comprising:
(d) transmitting the authorized software component information stored in the storage to the external device via the network;
(e) receiving authorized response information from the external device via the network in response to the authorized software component information transmitted in the transmitting (d); and
(f) receiving unauthorized response information from the external device via the network in response to the unauthorized software component information transmitted in the transmitting (c).

4. The control method according to claim 3, further comprising:
(g) discarding the unauthorized response information received in the receiving (f).

5. The control method according to claim 1,
wherein the generating (b) includes tampering with at least part of the authorized software component information stored in the storage to generate the authorized software component information tampered with as the unauthorized software component information.

6. The control method according to claim 5, further comprising:
(h) receiving response information from the external device via the network in response to the unauthorized software component information transmitted in the transmitting (c); and
(i) restoring tampered information included in the response information received in the receiving (h) to original information before tampering.

7. The control method according to claim 1,
wherein the authorized software component information includes a plurality of name information items that respectively indicate names of the plurality of software components, and
the generating (b) includes pseudonymizing each of the plurality of name information items included in the authorized software component information stored in the storage to generate the authorized software component information pseudonymized as the unauthorized software component information.

8. The control method according to claim 7, further comprising:
(j) receiving response information from the external device via the network in response to the unauthorized software component information transmitted in the transmitting (c); and
(k) restoring each of the plurality of name information items pseudonymized and included in the response information received in the receiving (j) to the plurality of name information items before pseudonymization.

9. A management device that manages authorized software component information indicating an inventory of a plurality of software components that make up software, the management device comprising:
a storage that stores the authorized software component information;
a generator that generates unauthorized software component information in accordance with the authorized software component information stored in the storage, the unauthorized software component information corresponding to software component information obtained by modifying at least part of the authorized software component information; and
a communicator that transmits the unauthorized software component information generated by the generator to an external device via a network.
